(19) United States
(12) Patent Application Publication
(10) Pub. No.: US 2006/0254846 A1
(43) Pub. Date: Nov. 16, 2006

(54) Device for monitoring a bonnet on a vehicle

(76) Inventor: Bernhard Mattes, Sachsenheim (DE)

Correspondence Address: KENYON & KENYON LLP, ONE BROADWAY, NEW YORK, NY, 10004, US

(21) Appl. No.: 10/548,990

(22) PCT Filed: Oct. 17, 2003
(86) PCT No.: PCT/DE03/03447

§ 371 Date: May 31, 2006

(30) Foreign Application Priority Data
Mar. 6, 2003 (DE) 103 09 715.5

(51) Int. Cl. B60R 21/00

(52) U.S. Cl. 180/268; 180/271

(57) ABSTRACT

A device is proposed for monitoring a front opening hood of a vehicle which is connected to a control unit for a restraint system. As a function of a signal from the device, a triggering algorithm in the control unit is influenced. The device monitors the closing state of the front opening hood, mechanical switches being preferably used.

### FIELD OF THE INVENTION

The present invention relates to a device for monitoring a front opening hood of a vehicle according to the species defined in the independent claim.

### BACKGROUND INFORMATION

It is known from German Published Patent Application No. 100 13 563 that one may lift up a front opening hood in case of a pedestrian impact, so as to reduce the danger of injury to the pedestrian.

The disadvantage is that the condition of the front opening hood is not monitored.

### SUMMARY OF THE INVENTION

It is an object of the present invention to create a device which provides monitoring a front opening hood and uses this signal for protecting the passengers.

By contrast, the device, according to the present invention, for monitoring a front opening hood of a vehicle has the advantage that at this point it will be detected whether a front opening hood is not closed, or not quite closed. This data item may then be taken into consideration in an algorithm for a restraint system. In particular, using this, the evaluation algorithm may be switched in a sharper manner, i.e. normally a threshold lowering may take place.

It is particularly advantageous that the device has at least one sensor for monitoring a closed state of the front opening hood. This sensor is preferably designed as a switch. However, contactless sensors such as a Hall element or even a force sensor are also possible. If a mechanical switch is used, this should advantageously be open when the front opening hood is closed, so that the switch contact is not stressed unnecessarily, since it may be assumed that, in the majority of cases, the front opening hood is closed, so that the contact stress is minimized. Then, whether the mechanical switch is open or closed is usually evaluated in a resistive circuit. As force sensors, for example, force-sensitive washers come into consideration.

Preferably, four sensors are used, respectively two in the front region of the front opening hood and two in the rear region of the front opening hood. This advantageously leads to redundancy in the sensing. In this context, the switch evaluation must make possible an error detection for a short circuit and an interruption, so that an analogous signal analysis is necessary.

Advantageously, when a switch is used as a sensor, it is operated by the front opening hood damper rubbers. This ensures an especially reliable signal for detecting the closing state of the front opening hood.

### BRIEF DESCRIPTION OF THE DRAWINGS

FIG. 1 shows a block diagram of the device according to the present invention.

FIG. 2 shows a positioning of the sensors for monitoring the closing state of the front opening hood.

FIG. 3 shows an evaluation circuit in a switch.

### DETAILED DESCRIPTION

In a frontal crash, the defined front opening hood deformation is one of the deciding factors for the crash-absorbing and energy-absorbing behavior of the vehicle's front structure. Only a front opening hood that was completely closed before the crash supplies the energy absorption on which the algorithm parameter setting is based.

The front opening hood, or in most cases also the engine hood, has to buckle upwards in a defined way between the front and possibly rear hood lock, and the rear or possibly front hinges, and must not penetrate the windshield. Only then does it deliver the desired front structure stiffening and the desired absorption behavior. In this context, it is obvious that a front opening hood that is hinged in the rear is safer in a crash than one that is hinged in the front. Two hinges hold a front opening hood more firmly or in position than a releasable lock. A hood cutting through the windshield would in most cases pose a devastating danger of passenger injury because of a guillotine effect.

Whether the front opening hood is completely closed before a crash is not being monitored at present. However, as was mentioned before, algorithm parameter settings are only valid for completely closed front opening hoods. In the case of a hood that is open in front or one that is only snapped into the first step, or, in the future, of a hood that is hinged in the back for the protection of pedestrians, the hood cannot absorb the expected crash energy and convert it into work of deformation. This means that the forces exerted on the passengers become greater faster. Since the vehicle's hard structural parts are hit faster, and the vehicle's front structure deformation is greater, the protective systems seat belt tensioning devices, seat belt force limiters, front air bags and knee bags must be activated faster. The triggering algorithm has to be set to a more sensitive set of parameters.

Even in the case of a hood that is raised at the rear for the protection of pedestrians, it must be ensured in the future that, when there is a front crash, it does not penetrate the windshield.

It is therefore proposed by the present invention that the state of the front opening hood be monitored. For this, at least one sensor is suggested for monitoring the closing state of the front opening hood. This sensor may preferably be a switch or a group of switches. However, sensors measuring in a contactless fashion are also a possibility, and also force sensors.

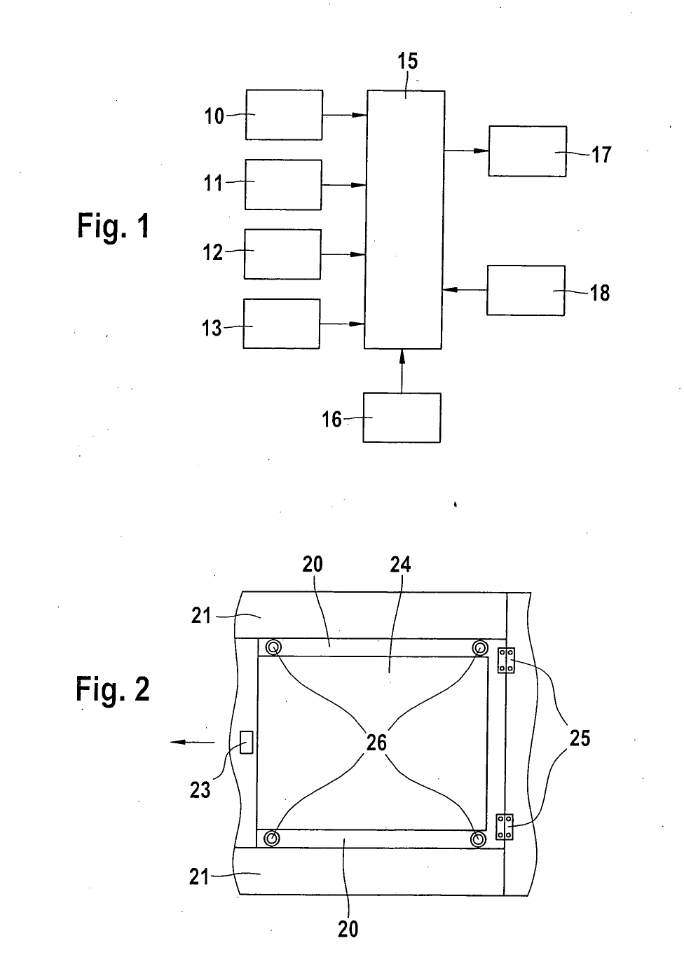

FIG. 1 shows the apparatus according to the present invention in a block diagram. Four switches 10 through 13, which monitor the closing state of the front opening hood, are connected to an air bag control unit 15 via electrical lines. Air bag control unit 15 thus detects from the signals of sensors 10 through 13 whether the front opening hood was correctly closed. Air bag control unit 15 is informed concerning the loading state of the vehicle and the crash severity by a cinematic sensor system 16, preferably acceleration sensors and precrash sensors 18. As a function of that, air bag control unit 15 calculates the triggering times for the means of restraint, such as the air bags or belt tensioners or rollover bars. According to these triggering times, air bag control unit 15 then activates means of restraint 17.

FIG. 2 shows an exemplary positioning of switches for monitoring the closing state of the front opening hood. A top view is shown onto open engine compartment bay 24, i.e. the front opening hood itself cannot be seen, but what is seen is what is covered by the front opening hood. In the rear region of the front opening hood two hinges 25 are provided, while in the front region of the front opening hood there is a hood lock 23. At the front opening hood seating surfaces 20, damping rubbers 26 are situated having force sensors or having switches for monitoring the closing state of the front opening hood. Engine compartment bay 24 is located between the front opening hood seating surfaces. Fenders 21 are seen on the outside. This arrangement is especially redundant with regard to sensing the closing state of the front opening hood, and is therefore especially safe.

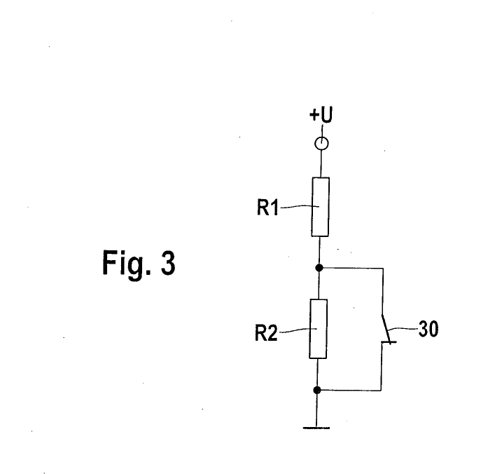

FIG. 3 shows in an exemplary circuit how a switch 30 is electrically interpreted. A resistor series circuit made up of resistors R1 and R2 has a specified voltage +U applied to it. Switch 30 is connected parallel to lower resistor R2, which is connected to ground. Thus, when the switch is closed, resistor R2 is short circuited. This changes the overall resistance of the apparatus, and at a specified voltage +U the current is increased. Even the partial voltages over resistors R1 and the parallel circuit made up of R2 and switch 30 change as a function of the closing state of the switch. That being the case, both the current flowing through the device and the partial voltages are suitable measuring quantities for detecting the switching state of switch 30.

1.-9. (canceled)

10. A device for monitoring a front opening hood of a vehicle, comprising:
an arrangement for connecting to a control unit for a restraint system and supplying a signal to influence a triggering algorithm in the control unit.

11. The device as recited in claim 10, further comprising:
at least one sensor for monitoring a closing state of the front opening hood.

12. The device as recited in claim 11, wherein:
the at least one sensor includes a mechanical switch.

13. The device as recited in claim 12, wherein:
the mechanical switch is open when the front opening hood is closed.

14. The device as recited in claim 11, wherein:
the at least one sensor measures in a contactless fashion.

15. The device as recited in claim 14, wherein:
the at least one sensor includes a Hall element.

16. The device as recited in claim 15, wherein:
the at least one sensor includes a force sensor.

17. The device as recited in claim 11, further comprising:
a first plurality of sensors arranged in a front region of the front opening hood; and
a second plurality of sensors arranged in a rear region of the front opening hood.

18. The device as recited in claim 12, wherein:
the mechanical switch is able to be operated by a front opening hood damper rubber.
